(19) United States
(12) Patent Application Publication
(10) Pub. No.: US 2017/0374307 A1
(43) Pub. Date: Dec. 28, 2017

(54) LOW-POWER AND LOW-MISMATCH CORRELATED DOUBLE SAMPLING (CDS) CIRCUIT

(71) Applicant: QUALCOMM Incorporated, San Diego, CA (US)

(72) Inventors: Soo Youn Kim, San Diego, CA (US); Alok Govil, Fremont, CA (US)

(21) Appl. No.: 15/192,735

(22) Filed: Jun. 24, 2016

(51) Int. Cl. H04N 5/378; H04N 5/369

(52) U.S. Cl. CPC H04N 5/378; H04N 5/3696

(57) ABSTRACT

Techniques provided herein are directed toward a simplified correlated double sampling (CDS) circuit that reduces the amount of components and potential noise sources utilized to two switches and a capacitor. Such CDS circuits can be used in conjunction with downstream programmable gain amp (PGA) circuitry to provide double sampling along with variable gain and/or other features. Embodiments may further utilize one or more analog muxes to reduce parasitic capacitance and increase accuracy.

### BACKGROUND

Cameras used in devices such as mobile phones, tablets, personal media players, digital cameras, surveillance systems, and the like comprise arrays of sensor elements, or pixels, arranged in two dimensions in order to obtain a two-dimensional image of a scene. Correlated double sampling (CDS) circuits are widely used with these arrays to reduce column fixed pattern noise (FPN), thereby increasing the accuracy of the pixel values produced by the arrays. Traditional CDS circuits, however, include a variety of components that may themselves be a source of noise and can be difficult to reduce in scale at the same rate that pixel sizes are being reduced.

### SUMMARY

Techniques provided herein are directed toward a simplified correlated double sampling (CDS) circuit that reduces the amount of components and potential noise sources utilized to two switches and a capacitor. Such CDS circuits can be used in conjunction with downstream programmable gain amplifier (PGA) circuitry to provide double sampling along with variable gain and/or other features. Embodiments may further utilize one or more analog multiplexers (muxes) to reduce parasitic capacitance and increase accuracy.

An example apparatus for providing image sensing, according to the disclosure, comprises an active pixel sensor array comprising a pixel array having a plurality of columns of pixels, and, for each column of pixels of the plurality of columns of pixels of the active pixel sensor array, a correlated double sampling (CDS) circuit corresponding to, and coupled with, the each column of pixels, wherein each CDS circuit comprises a first switch, a first capacitor, and a second switch, wherein, for each CDS circuit. The first capacitor is connected in series between the first switch and the second switch without an active element disposed between the first capacitor and the second switch, and an input of the first switch is coupled to an output of the corresponding column of pixels. The apparatus further includes an amplification circuit comprising a second capacitor and a third switch connected in parallel with the second capacitor, wherein, for the each CDS circuit, an output of the second switch of is coupled to an input of the amplification circuit.

An example method of providing image sensing, according to the disclosure comprises obtaining, for each column of pixels in an active pixel sensor array, a first value from a pixel sensor in the column of pixels, and storing, for each column of pixels in the active pixel sensor array, the first value with a corresponding CDS circuit comprising a first switch, a first capacitor, and a second switch. The first capacitor is connected in series between the first switch and the second switch without an active element disposed between the first capacitor and the second switch, and an input of the first switch is coupled to an output of the corresponding column of pixels. The method further comprises providing, with an amplification circuit coupled to each of the CDS circuits, a plurality of output signals, wherein each output signal corresponds to a column of pixels in the active pixel sensor array, and is based on the first value stored by the CDS circuit corresponding to the column of pixels and a second value obtained by the CDS circuit corresponding to the column of pixels. The amplification circuit comprises a second capacitor and a third switch connected in parallel with the second capacitor.

Another example apparatus, according to the disclosure, comprises means for obtaining, for each column of pixels in an active pixel sensor array, a first value from a pixel sensor in the each column of pixels, means for storing, for each column of pixels in the active pixel sensor array, the first value within a corresponding CDS circuit that does not include a buffer or amplifier, and means for providing a plurality of amplified output signals. Each output signal corresponds to a column of pixels in the active pixel sensor array, and is based on the first value stored by the means for storing and a second value obtained by the means for storing CDS circuit corresponding to the column of pixels

An example non-transitory computer-readable medium, according to the disclosure, comprises instructions for causing an apparatus to provide image sensing. The instructions include computer code for obtaining, for each column of pixels in an active pixel sensor array, a first value from a pixel sensor in the column of pixels, storing, for each column of pixels in the active pixel sensor array, the first value with a corresponding CDS circuit comprising a first switch, a first capacitor, and a second switch, where the first capacitor is connected in series between the first switch and the second switch without an active element disposed between the first capacitor and the second switch, and an input of the first switch is coupled to an output of the corresponding column of pixels. The instructions further comprise computer code for providing, with an amplification circuit coupled to each of the CDS circuits, a plurality of output signals, wherein each output signal corresponds to a column of pixels in the active pixel sensor array, and is based on the first value stored by the CDS circuit corresponding to the column of pixels and a second value obtained by the CDS circuit corresponding to the column of pixels, and the amplification circuit comprises a second capacitor and a third switch connected in parallel with the second capacitor.

### BRIEF DESCRIPTION OF THE DRAWINGS

An understanding of the nature and advantages of various embodiments may be realized by reference to the following figures.

FIG. 1 is a block diagram of circuitry utilized in traditional CDS circuits.

FIGS. 2A and 2B are schematic diagrams of circuitry utilized in traditional CDS circuits.

FIG. 3 is a schematic diagram of circuitry that utilizes a modified CDS circuit and PGA, according to various embodiments.

FIG. 4 is a schematic diagram illustrating CDS circuits for the first three columns of pixels, each circuit comprising two switches and one capacitor, in the same manner as the CDS circuit of FIG. 3.

FIG. 5 is a timing diagram of various signals of the circuitry of the schematic diagram for FIG. 4 during operation, according to one embodiment.

FIGS. 6A-6B are schematic diagrams of different configurations of a circuit.

FIG. 7 is an illustration of a graph and tables that provide simulation results of an embodiment described herein.

FIG. 8 is a schematic diagram of CDS and PGA circuitry, according to another embodiment.

FIG. 9 is a schematic diagram of an embodiment of CDS and PGA circuitry that utilizes a series of muxes to help reduce the effects of parasitic capacitance in the circuitry.

FIG. 10 is a flow diagram of a method of providing signals with correlated double sampling (CDS), according to an embodiment.

FIG. 11 illustrates an embodiment of a mobile device.

### DETAILED DESCRIPTION

The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

As used herein, the term “mobile device” can include any of a variety of portable electronic devices, such as mobile phones, tablets, portable media players, wearable devices, and the like. And although embodiments provided herein are described in terms of mobile devices, embodiments are not so limited. For example, embodiments may utilize stationary battery-powered devices, devices that are not battery powered, and more. A person of ordinary skill in the art will recognize that techniques and features described herein may be utilized in many different applications.

It should be noted that the embodiments herein describe values from pixel sensors (intensity values sensed by and/or associated with pixels) as being indicated with voltage values. However, it will be appreciated that other analog or digital values (e.g., currents) may additionally or alternatively be utilized. It can be further noted that, for the embodiments disclosed herein the terms “pixel,” “pixel sensor,” and “active pixel sensor” (or “APS”) are used interchangeably, referring to a single element of a pixel sensor array, such as an APS array.

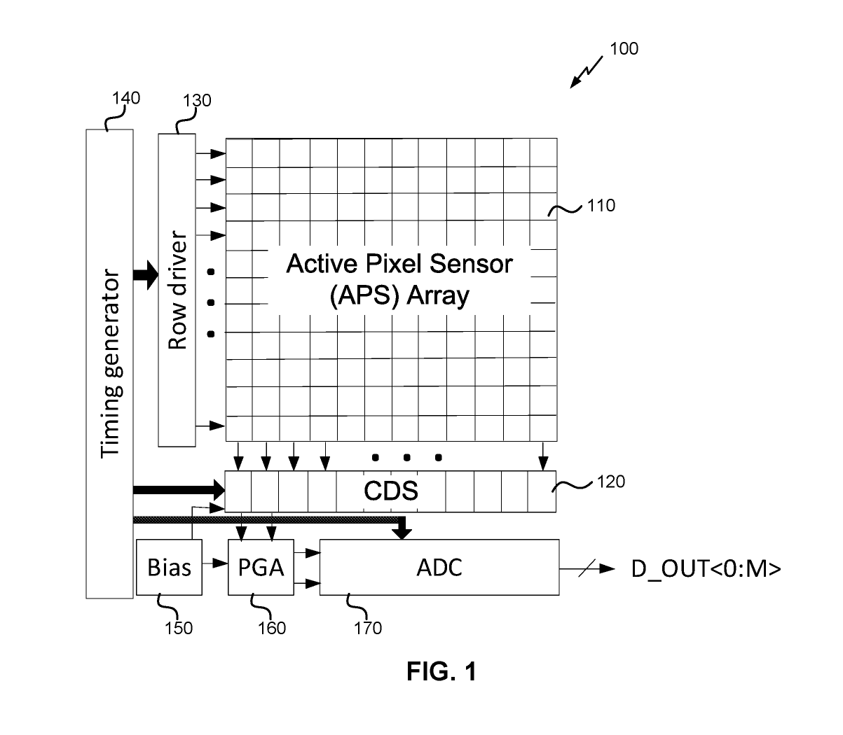

FIG. 1 is a simplified block diagram of camera circuitry 100, according to one embodiment. For example, an apparatus for providing image sensing can comprise camera circuitry 100. Here, the camera circuitry comprises an active pixel sensor (APS) Array 110, correlated double sampling (CDS) circuitry 120, row driver circuitry, a timing generator 140, bias circuitry 150, a programmable gain amplifier (PGA) 160, and an analog to digital converter (ADC) 170. It will be understood, however, that embodiments may employ any number of variations. Components may be added, separated, removed, and/or rearranged, depending on desired functionality.

The APS array 110 comprises an array of pixel sensors arranged in rows and columns. When exposed to the light, each pixel sensor generates a value (e.g., a voltage or current value) that represents, for example, and intensity of the light sensed by the pixel sensor. The APS array 110 may include monochrome and/or color pixel sensors, depending on desired functionality. Although the APS array 110 shown in FIG. 1 has an arbitrary amount of rows and columns (11 rows and 12 columns, in the illustration), it is provided for illustrative purposes. The actual number of rows and/or columns in a particular embodiment of an APS array 110 can vary. Common resolutions include 160×160, 240×320, 320×480, 480×720, 1024×768, 1080×1920, and more, although embodiments are not so limited. Resolution, color, and/or other features of the APS array 110 may be chosen depending on the applications for which the camera will be used.

According to some embodiments, the general operation of the camera circuitry 100 is as follows. Camera optics (not shown) focus light onto the APS array 110, and the pixel sensors generate pixel values that are read from the APS array 110 a row at a time. The row driver 130 selects a row of the APS array 110 (e.g., by causing a row select output for a selected row to switch from a low to a high voltage) and the pixel values are provided to the CDS circuitry 120. Through a process explained in more detail below, the CDS circuitry 120 (which includes a CDS circuit for each column of the APS array 110) removes noise from the value of each pixel in the row, and provides pixel values to the PGA 160, one pixel at a time. The PGA 160, which buffers and optionally amplifies the signal from the CDS circuitry 120, provides pixel values to the ADC 170, which converts the pixel values to a digital value. All of this is orchestrated by the timing generator 140, the bias circuitry 150 providing a bias voltage and/or current as needed, and a digital output (labeled “D_OUT<0:M>” in FIG. 1) of pixel values in the row (e.g., for M columns) is provided to downstream circuitry (e.g., image processing circuitry, a central processing unit, etc.). This process is repeated for each row in the APS array 110 until the values of all pixel sensors the APS array 110 are sampled and communicated via the digital output. In traditional implementations of camera circuitry 100, the CDS circuitry 120 and PGA 160 serve discrete functions to reduce column fixed pattern noise (FPN) and provide buffering/amplification, respectively, as needed.

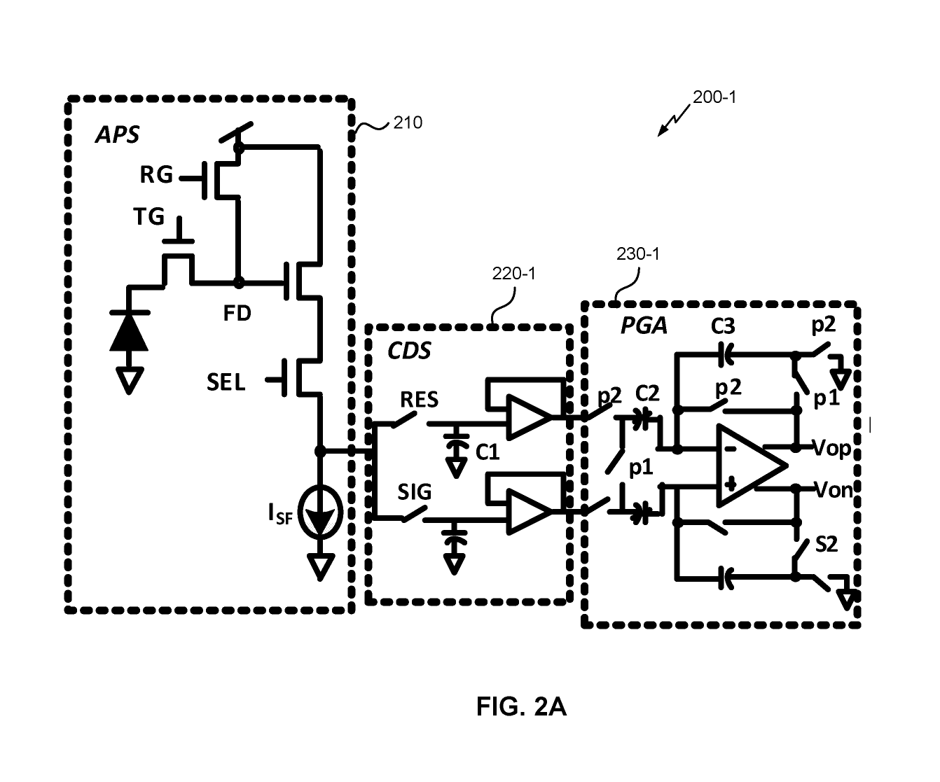

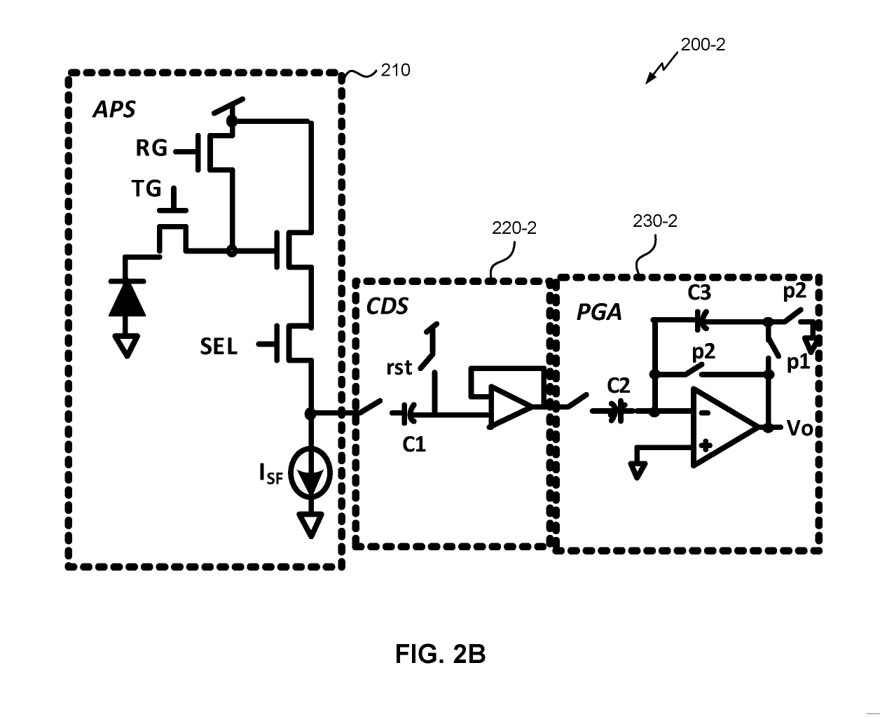

FIG. 2A is a schematic diagram of circuitry utilized in traditional CDS circuits. Here, the circuitry 200-1 shows a single active pixel sensor (APS) 210 connected to a single CDS circuit 220-1. The outputs of the CDS circuit are connected to the PGA 230-1 (which may correspond to the PGA 160 of FIG. 1). It will be understood however that the CDS circuit 220-1 is one of a plurality of CDS circuits 220-1 in the CDS circuitry 120 of camera circuitry 100 of FIG. 1. (In actuality, there will generally be a CDS circuit 220-1 for each column of the APS array 110. A single APS 210 and CDS circuit 220-1 are shown here for simplicity.) It will further be understood that the CDS circuit 220-1 will be connected to a plurality of APSs 210. (An APS 210 for each row of the APS array 110.) However, because only one APS 210 is selected at a time (e.g., by using the SEL input shown in APS 210), only a single APS 210 is shown.

The CDS circuit 220-1 is a type of “sample and hold” circuit that, as illustrated, traditionally comprises two switches, two capacitors, and two buffers. Simply put, the CDS circuit 220-1 samples and holds output values of the APS 210 twice: once during the reset of the pixel value to capture the source follower signal (during which the SEL input to the APS 210 is low, the RES switch of the CDS circuit 220-1 is turned on, and the SIG switch is turned off), and once during the readout of the pixel signal value (during which the SEL input to the APS 210 is high, the RES switch of the CDS circuit 220-1 is turned off, and the SIG switch is turned on). These reset and signal values are fed to the PGA 230-1, which then subtracts the signal value from the reset value and provides resulting value to the ADC. Since each source follower varies from one column to the next (a noise known as column fixed pattern noise (FPN)), this subtraction of the reset and signal values provided by the CDS circuit 220-1 helps minimize these variations and increase the accuracy of the image captured by the camera. (The source follower current is represented in FIG. 2A as I_{SF}.) The RES switch of CDS circuit 220-1 captures the pixel reset value when a reset control signal RG is logic high, while the SIG switch captures pixel signal value after a transfer control signal TG is turned on to transfer photo charges collected in the photo diode to the floating diffusion (FD) node.

Because there is a CDS circuit 220-1 for each column of the APS array 110, the components of the CDS circuit 220-1 are typically laid out such that they match—at least to a degree—the pitch of each column of the APS array 110. Currently, for example, careful layout is required to put all of the components of the CDS circuit 220-1 into a limited area of approximately 2-10 μm (where the pixel pitch is approximately 1-5 μm). To help ensure accuracy from one column to the next, the CDS circuit 220-1 for each column must be matched as closely as possible. This can be difficult with the amount and complexity of the components in the CDS circuit 220-1. Additionally, the buffers of the CDS circuit 220-1 are a source of noise and increased power consumption of the circuitry 200-1. Techniques provided herein utilize modified circuitry that addresses these and other issues. Hence, for example, in some implementations, CDS circuit 220-1 can have lower power consumption if CDS circuit 220-1 does not include an active element, such as, for example, an operational amplifier (op amp). For example, in some implementations described below, an operational amplifier near the output of the CDS circuit 220-1 may be omitted to allow for a low power CDS circuit.

FIG. 2B is schematic diagram of other circuitry utilized in traditional CDS circuits. Similar to FIG. 2A, the circuitry 200-2 shows a single APS 210 connected to a single CDS circuit 220-2 which provides a signal to a PGA 230-2. Here, components of the CDS circuit 220-2 and PGA 230-2 differ from those shown in FIG. 2A, although the circuitry in FIG. 2B may suffer from some of the same problems. Namely, the buffer of the CDS circuit 220-2 can be a source of noise and increased power consumption of the circuitry 200-2. As noted above, CDS circuit 220-2 can have lower power consumption if CDS circuit 220-2 does include an active element, for example, an op amp.

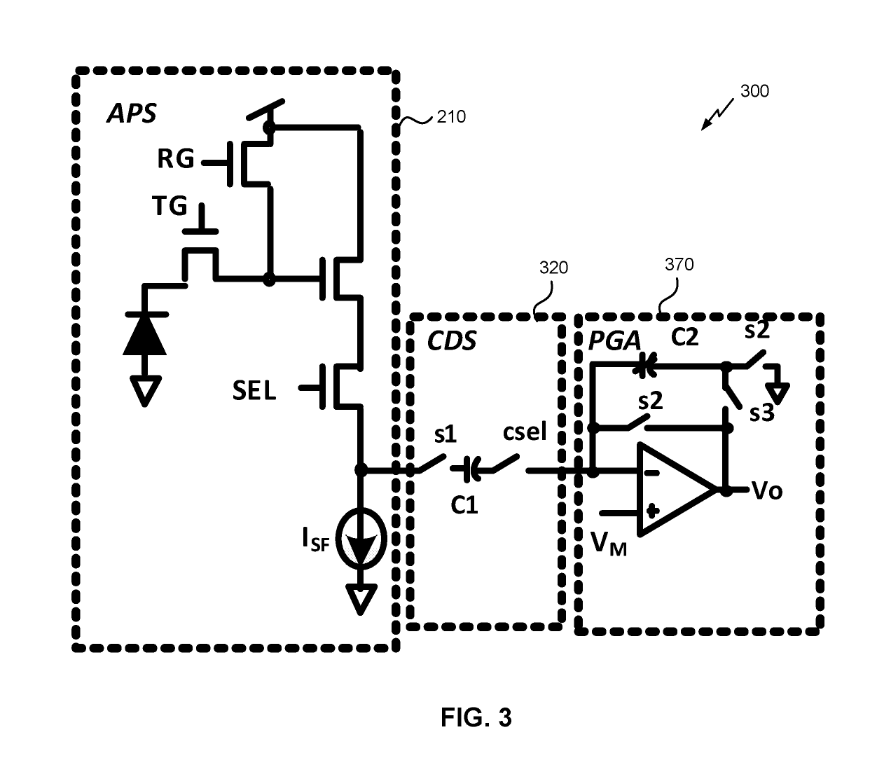

FIG. 3 is a schematic diagram of circuitry 300 that utilizes a modified CDS circuit 320 and PGA 370, according to various embodiments. In one example, an apparatus for providing image sensing can comprise circuitry 300. As can be seen, while the APS 210 is identical to the APS 210 of FIGS. 2A and 2B, the modified CDS circuit 320 and the modified PGA 370 are different than their counterparts in FIGS. 2A and 2B.

The modified CDS circuit 320 and the modified PGA 370 are far simpler in design. According to some embodiments, and as illustrated in FIG. 3, the modified CDS circuit 320 comprises only two switches: a first switch (s1) and a second switch (csel (column select)) and a first capacitor (C1). In the modified CDS circuit 320, no active element, for example an op amp, is disposed between the first capacitor and an output of the CDS circuit 320. In one example, no active element is disposed between the first capacitor and the second switch, where the output of the second switch comprises the output of the CDS circuit 320. In some implementations, the modified CDS circuit 320 includes only passive elements and transisters serving only as switches and includes no active element except for such switch transisters. Hence, in some implementations, the CDS circuit 320 does not include a buffer or an amplifier. The modified PGA 370 includes an op amp, two switches (s2 and s3), and a second capacitor, C2. One of the two switches, a third switch (s2), is connected in parallel with the second capacitor, C2. By adjusting the ratio between C1 and C2, analog gain can be determined and/or controlled.

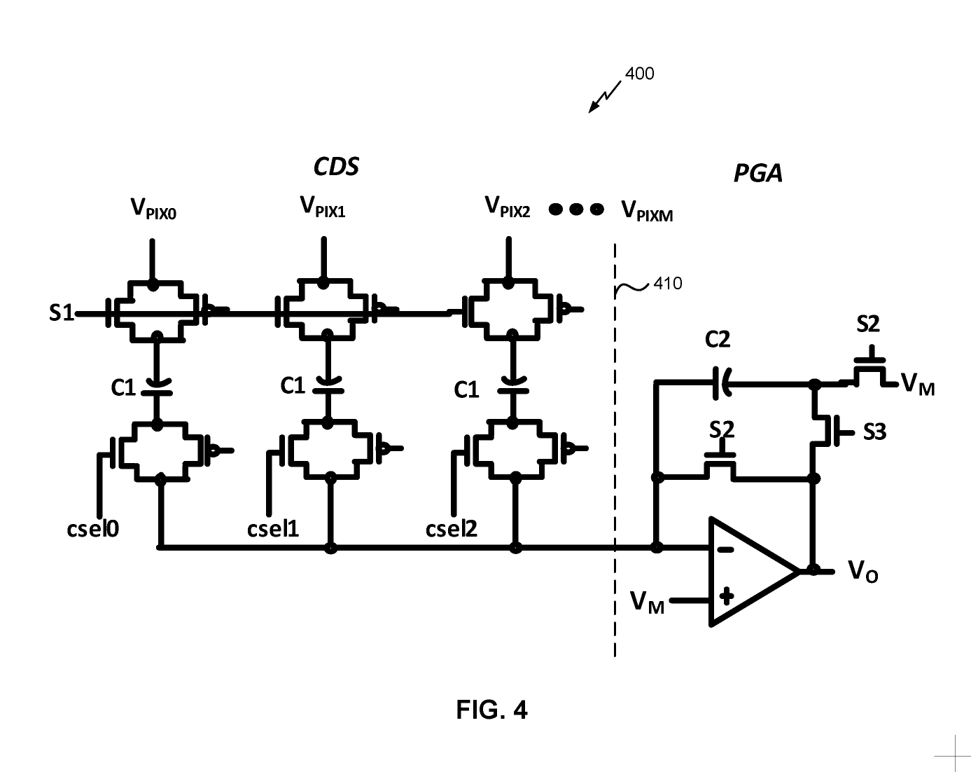

Bearing in mind that the modified CDS circuit 320 is replicated for every column of the APS array 110, the benefits of the simplification of the modified CDS circuit 320 are compounded in view of the overall camera circuitry 100 of FIG. 100. In particular, a buffer (op amp) is no longer included for every column of the APS array 110, which drastically simplifies the design and layout of the camera circuitry 100 and reduces the amount of power used and noise generated. Hence, as will be understood by one of skill in the art, CDS circuit 320 includes a means for storing, for each column of pixels in the active pixel sensor array, a first value from a pixel sensor in each column within the corresponding CDS circuit 320, where the CDS circuit 320 does not include a buffer or an amplifier. The operation of the circuitry 300 is discussed in further detail with regard to FIGS. 4-6B below.

FIG. 4 is a schematic diagram 400 illustrating CDS circuits for the first three columns of pixels (to the left of line 410), each circuit comprising two switches (first and second switches, S1 and csel) and a first capacitor (C1), in the same manner as the modified CDS circuit 320 of FIG. 3. The schematic diagram 400 also shows a PGA (to the right of line 410) corresponding to the PGA 370 of FIG. 3. It can be noted that, for an APS array 110 having a plurality of columns of pixels, for example, M columns, each of the CDS circuits would be replicated M times. It can be further noted that, although transmission gates and similar types of switches are utilized in the schematic diagram 400, other switches may be utilized, depending on desired functionality. Moreover, embodiments may reverse the inputs of the op amp of the PGA or make similar variations, as dictated by design requirements or other factors.

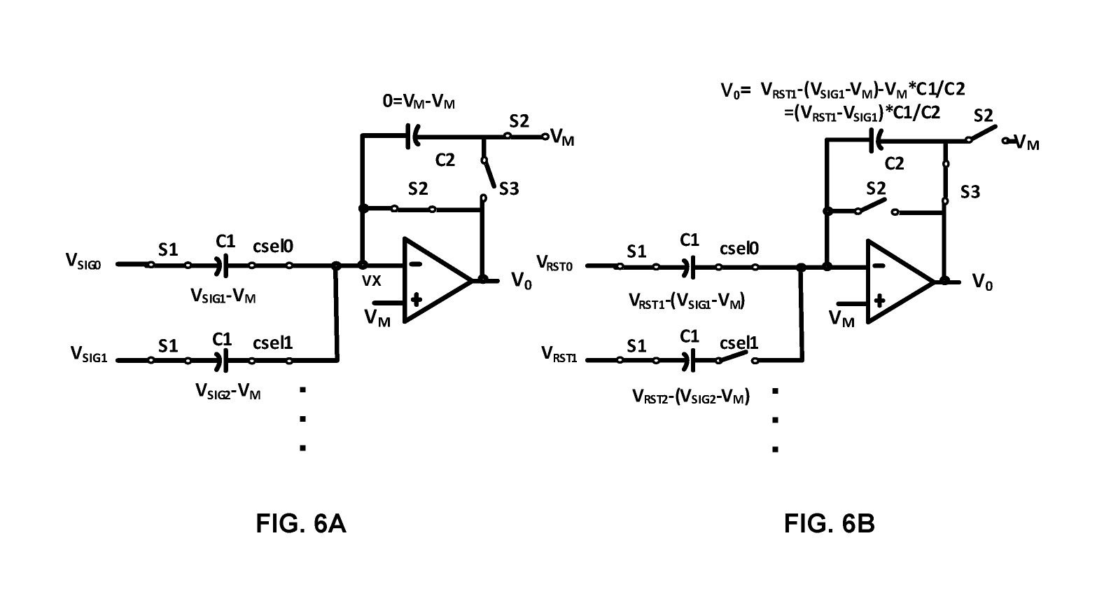

It can be noted that V_{M} is a DC bias voltage provided from bias circuitry (e.g., bias circuitry 150 of FIG. 1). In the inverting amplifier topology, output voltage is equal to the voltage at the “+” input minus the voltage at the “−” input. Thus, V_{O}=V_{M}−V_{X} (as shown in FIG. 6A). The value of V_{M} can be selected in accordance with techniques that would be appreciated by a person of ordinary skill in the art to ensure nMOS input transistors of the op amp operate within in the saturation region.

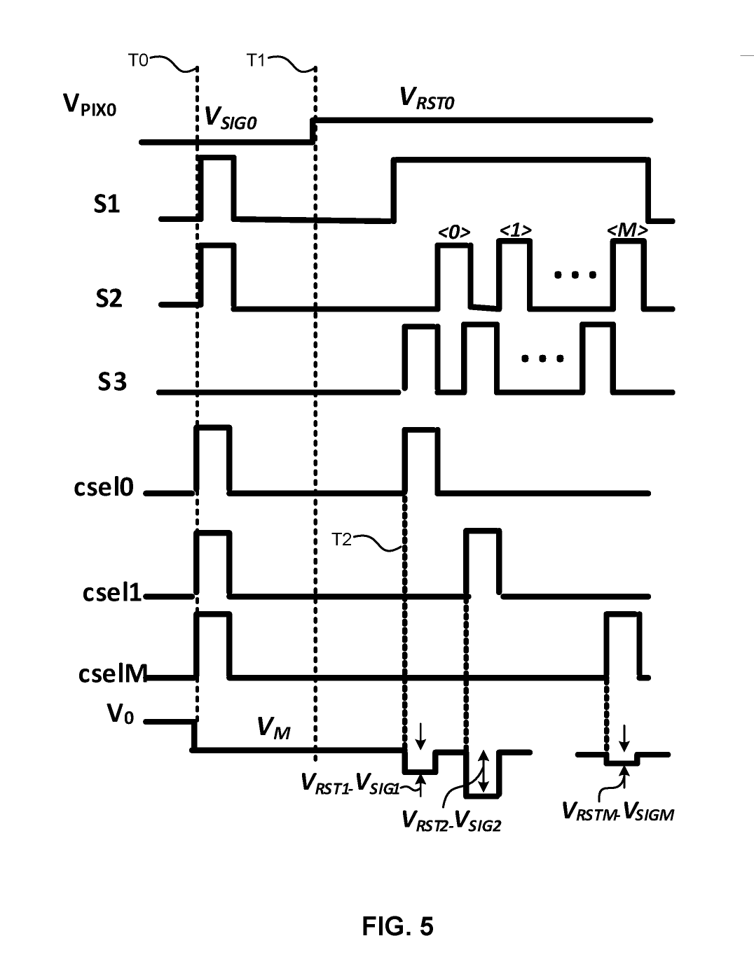

FIG. 5 is a timing diagram of various signals of the circuitry of the schematic diagram 400 during operation, according to one embodiment. As shown in the timing diagram, operation is as follows.

The signal voltages, V_{SIG}, for all columns are captured on corresponding capacitors, C1, by turning on switches S1, S2, and the csel switch for all columns (e.g., csel0, csel1, . . . , cselM) at time T0. The output voltage, V₀, becomes V_{M}, because switches S2 short the output of the op amp of the PGA to the input value V_{M}. For illustrative purposes, a schematic diagram of this configuration of the circuit is provided in FIG. 6A. (It should be noted that, for simplicity, the CDS circuits for only the first two columns are illustrated in FIGS. 6A and 6B.)

Once switches S1, S2, and the csel switch for all columns are turned back off, the reset voltage (V_{RST}) is applied at time T1, and the reset voltage minus the signal voltage (V_{RST}-V_{SIG}) is read out column by column, starting at time T2, by turning on switches S3 and csel (for the column) while S1 is on. For illustrative purposes, a schematic diagram of the configuration of the circuit for reading the output voltage for the first column (selected with signal csel0) is provided in FIG. 6B. As shown in FIG. 6B, the output voltage V₀ becomes the reset voltage minus the signal voltage (V_{RST}−V_{SIG}), multiplied by an amplification factor, or gain, of the PGA: C1/C2. After the value for each column is read and before the next column is read, the output voltage of the PGA is reset by briefly turning on S2 once S3 and csel (for the column) are turned off.

Simulated results show that the circuitry illustrated in FIGS. 3-6B provides very desirable results, with little variation in the output voltage of the PGA under different variations in input offset voltage.

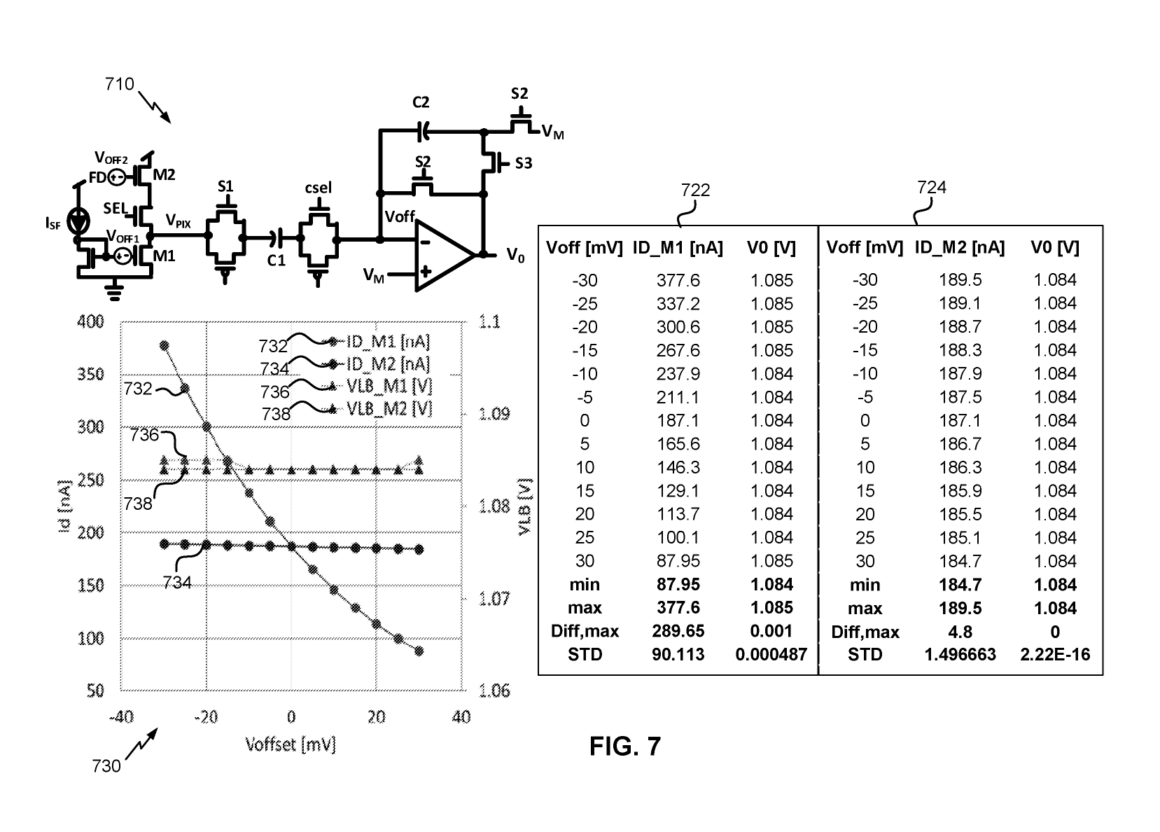

FIG. 7 illustrates a graph and tables that provide simulation results. Here, the output voltage, V₀, of the simulation circuit 710 was determined for values of offset voltages, V_{off}, ranging from −30 mV to 30 mV. Offset voltages were provided at transistors M1 and M2 of the pixel sensor circuit within simulation circuit 710, and charts 722 and 724 chart the respective output voltage corresponding to these offset voltages.

As can be seen, variations in the offset voltages V_{off} had very little impact in the output voltage V₀. With regard to changes in the offset voltage at transistor M1, as shown in chart 722, the standard variation in the output voltage V₀ was 0.487 mV, with the maximum variation being 1 mV. Chart 724 indicates that the output voltage V₀ was affected far less by offset voltages at transistor M2. Graph 730 illustrates the relationship between varying drain currents 732 and 734 of M1 and M2, respectively, and corresponding output voltages 736 and 738.

These variations in the output voltage may be undetectable by downstream circuitry. For example, where the output voltage varies from 0 V to approximately 1 V and the ADC to which the output voltage of the PGA is connected provides 8-bit ADC conversion (providing 256 unique output levels), the granularity of each step of the ADC is 1 V/246, or approximately 4 mV. Thus, a standard variation in the output voltage V₀ of 0.487 mV (or even a maximum variation of 1 mV) is unlikely to impact the value of digitally-converted output. (And in the instances in which it does impact the value of the digitally converted output, it would only change the output value at most by 1 on a scale of 0 to 255.) As such, the modified CDS circuit 320 and the modified PGA 370 of FIG. 3, when operated as described herein, provide a robust solution for reducing fixed pattern noise (FPN) with components that can be scaled down to pitches far smaller than the components of traditional CDS circuitry.

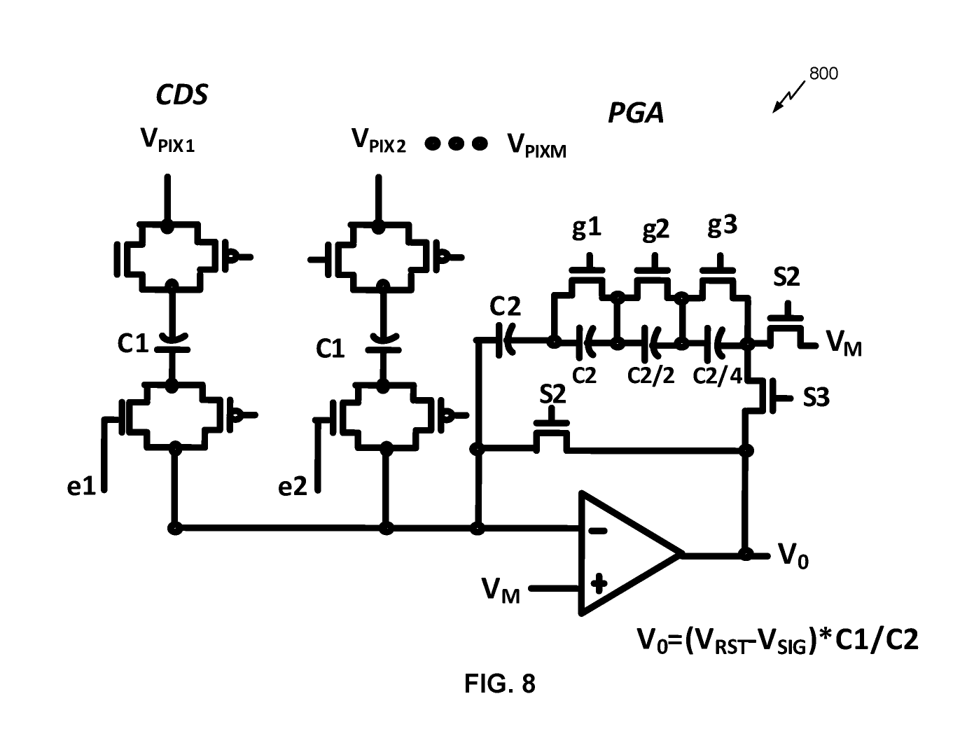

FIG. 8 is a schematic diagram 800 of CDS and PGA circuitry, according to another embodiment. As with others figures herein, FIG. 8 is provided as a non-limiting example; embodiments are not necessarily so limited. Additionally, similar to the schematic diagram 400 of FIG. 4, the schematic diagram 800 of FIG. 8 includes CDS circuits for only the first two columns of the APS array 110. In practice, for an APS array 110 with M columns, there will be a corresponding amount of M CDS circuits.

Here, the PGA circuitry includes a plurality of switches (g1, g2, and g3) connected in parallel with a plurality of additional capacitors (C2, C2/2, and C2/4) such that the amount of capacitance is adjustable by turning on and off the switches to bypass one or more of the plurality of additional capacitors. To be clear, for a given value of C2, the capacitors C2/2 and C2/4 have ½ and ¼ the capacitance of C2, respectively. If C2=C1, this allows for a 1-8× gain depending on how the switches are configured, as reflected in the following table:

TABLE 1
Variable Gain of PGA Circuitry

| g1 | g2 | g3 | Gain (C1/C2) |
|---|---|---|---|
| on | On | on | 1x |
| off | On | on | 2x |
| off | Off | on | 4x |
| off | Off | off | 8x |

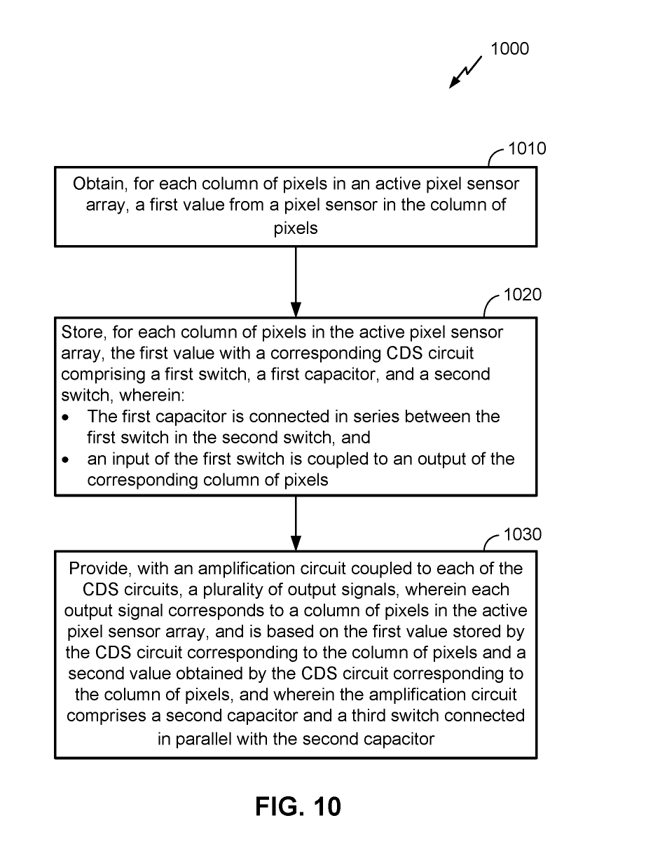

Here, when switches g1, g2, and g3 are all turned on, the additional capacitors (C2, C2/2, and C2/4) are bypassed, which increases the capacitance (because the additional capacitors are connected in series). And because C2=C1, the gain of the APS is 1. When switches g1, g2, and g3 are all turned off, the additional capacitors serve to decrease the capacitance to ⅛ the value of C2, thereby leading to a gain of 8. As indicated in Table 1, other gains are achievable by activating switches g1, g2, and g3 in different combinations. Of course, other embodiments may include additional or alternative values for the additional capacitors, thereby making additional or alternative gain values possible, depending on desired functionality. By adjusting the capacitance value as described above using the plurality of switches (g1, g2, and g3), the amount of amplification, or gain, by the amplification circuit, can be adjusted using the plurality of switches. Second capacitor discussed below with reference to FIG. 10 can, for example, be included as one of the additional capacitors discussed above.

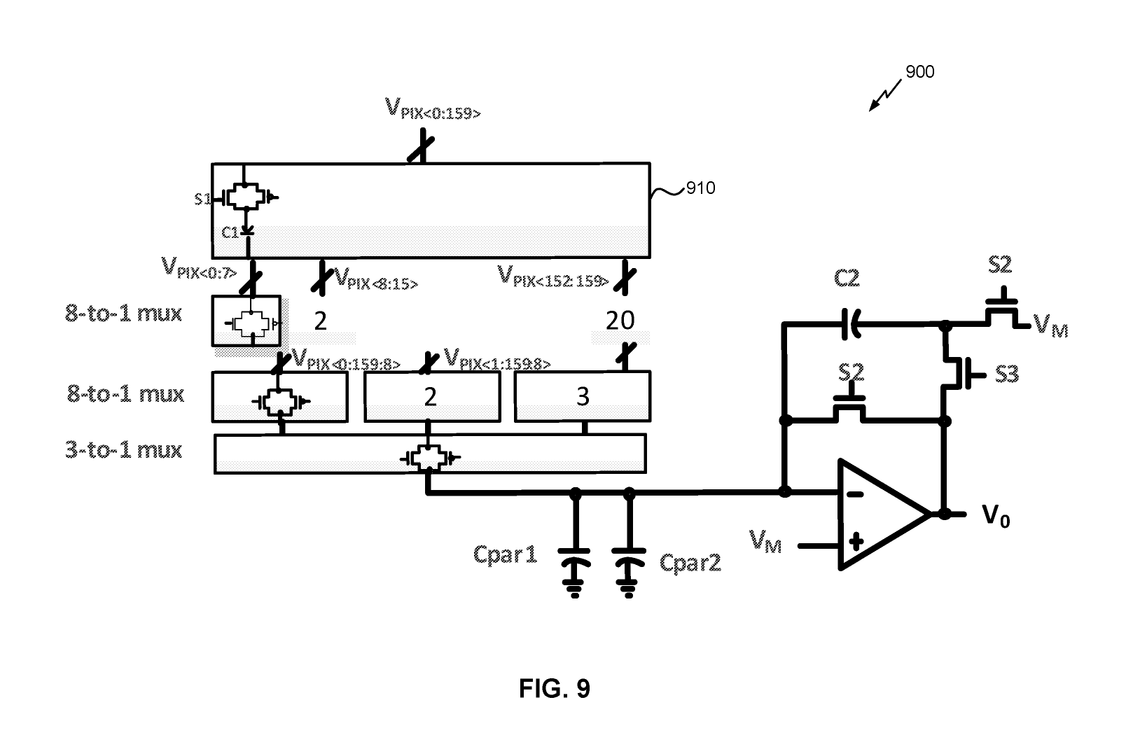

FIG. 9 is a schematic diagram 900 of an embodiment of CDS and PGA circuitry that utilizes a series of multiplexers (muxes) to help reduce the effects of parasitic capacitance in the circuitry. In the circuitry provided herein, parasitic capacitance can arise from two different sources. One source, represented in the schematic diagram 900 as Cpar1, is the drain capacitance of the column select (csel) switches in the CDS circuitry. Another source, represented in the schematic diagram 900 as Cpar2, is the capacitance from the input capacitor of the op amp in the PGA circuitry. The utilization of a series of analog muxes, as shown in the schematic diagram 900, can reduce Cpar1, which leads to a better slew rate (faster response times) of the PGA, and higher gain precision (e.g., by making the ratio of C1/C2 more accurate).

In the schematic diagram 900, 160 inputs correspond with 160 columns in the APS array 110. (For simplicity, the circuitry in the boxes of the schematic diagram 900 has been simplified, showing only a single switch, whereas the actual circuitry utilized may include several switches—one for each input. A person of ordinary skill in the art will appreciate the actual circuitry utilized.) An initial layer of circuitry 910 comprises 160 switches S1 and capacitors C1, similar to what is shown in FIG. 4. However, rather than having 160 csel switches connecting to the input of the PGA circuitry, three layers of muxes are used to reduce the amount of switches connected with op amp of the PGA circuitry to just three. Here, the three layers of muxes comprise a first layer of 20 8-to-1 muxes, which reduce the 160 inputs to 20 outputs, which are provided to a second layer of 8-to-1 muxes. The a second layer of 8-to-1 muxes reduces the 20 outputs of the first layer of 8-to-1 muxes down to three, which are provided to a third layer comprising a single 3-to-1 mux. The output of the 3-to-1 mux is then provided to the input of the PGA circuitry. Put differently, the CDS circuitry for each of the 160 columns of pixels (V_{PIX}<0:159>) in the embodiment illustrated in FIG. 9 includes a first switch and a capacitor (both in the initial layer of circuitry 910) and a second switch (the first layer of 8-to-1 muxes, where the second switch is shared among columns). An output of the second switch is then coupled to an input of the PGA amplification circuit via additional muxes.

Of course, alternative embodiments may include a larger or smaller number of columns than what is shown in FIG. 9. Accordingly, a different configuration of muxes may be utilized to narrow down the amount of inputs provided to the PGA circuitry. A person of ordinary skill in the art will recognize how this can be done for a given embodiment, given a certain amount of columns in the APS array 110 of that embodiment. It can be noted that the utilization of muxes in this manner is still preferable over previous CDS solutions because such muxes are global (they do not need to be repeated with each column) and therefore they do not need to match the pixel pitch of the APS array 110.

Such muxes may not be utilized in every embodiment. For example, in embodiments with an APS array 110 having relatively few columns, the amount of parasitic capacitance from csel switches may not result in errors that would necessitate the utilization of muxes. In some embodiments, the determination of whether to include a mux is based on the amount of error the system downstream (e.g., the ADC) can handle. A person of ordinary skill in the art would appreciate these considerations when determining whether to use one or more muxes.

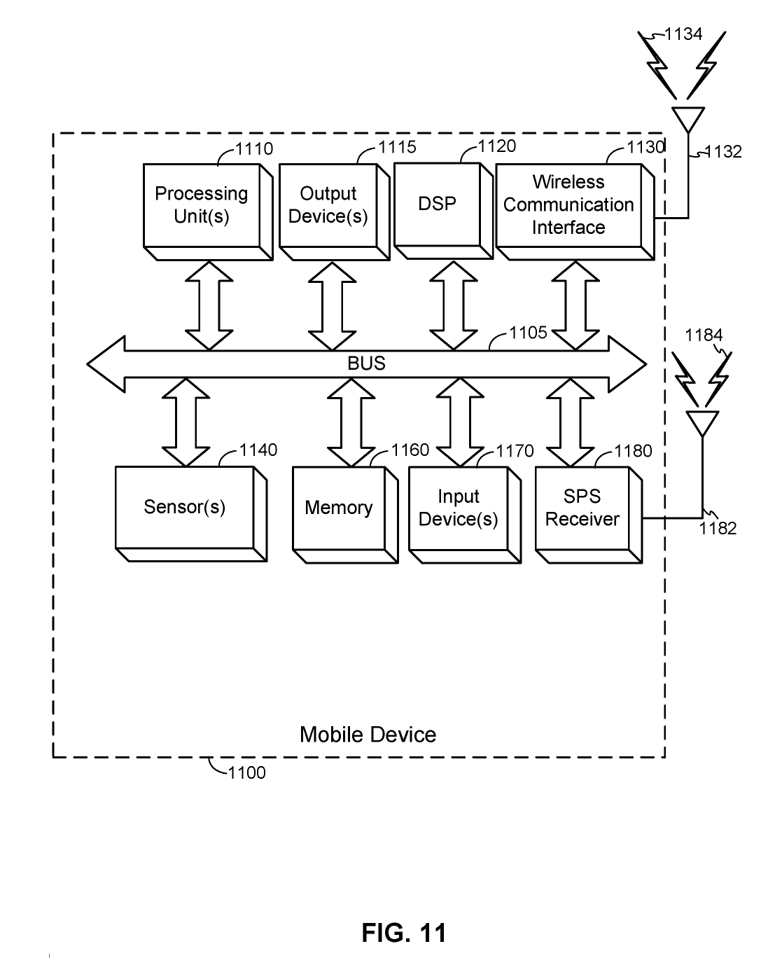

FIG. 10 is a flow diagram 1000 of a method of providing signals with correlated double sampling (CDS), according to an embodiment. As with other figures provided herein, FIG. 10 is provided as a non-limiting example. Alternative embodiments may include additional functionality to that shown in the figure, and/or the functionality shown in one or more of the blocks in the figure may be omitted, combined, separated, and/or performed simultaneously. Means for performing the functionality of the blocks may include circuitry as described in the embodiments above, and/or other hardware and/or software of a device, such as the mobile device shown in FIG. 11 and described below. A person of ordinary skill in the art will recognize many variations.

At block 1010, for each column of pixels in an active pixel sensor array, a first value is obtained from a pixel sensor in the column of pixels. As explained previously, the first value be obtained by CDS circuitry by closing switch S1 in the manner illustrated in FIG. 6A. Means for performing the functionality at block 1010 may therefore comprise the switch S1, as well as any or all components of the APS 210 as illustrated in FIG. 3.

At block 1020, for each column of pixels in the active pixel sensor array, the first value is stored with a corresponding CDS circuit, where the corresponding CDS circuit comprises a first switch, a first capacitor, and a second switch. The first capacitor (e.g., C1 in FIGS. 3, 4, 6A, 6B, 8, and 9) is connected in series between the first switch and the second switch and therefore serves as means for storing the first value as described in block 1020. An input of the first switch is coupled to an output of the corresponding column of pixels. In some implementations, no active element is disposed between the first capacitor and the second switch. Alternatively or additionally, the corresponding CDS circuit includes only passive elements and transisters serving only as switches and includes no active element except for such switch transisters. As indicated above, the second switch may be connected with an amplification circuit (e.g., APS circuitry) via a series of one or more muxes.

At block 1030 an amplification circuit coupled to each of the CDS circuits provides a plurality of output signals, where each output signal is based on the first value stored by a corresponding CDS circuit and a second value obtained by the corresponding CDS circuit, wherein the amplification circuit comprises a second capacitor and a third switch connected in parallel with the second capacitor. Stated differently, the amplification circuit (e.g., PGA circuitry shown in FIGS. 3, 4, 6A, 6B, 8, and 9) can serve as a means for providing a plurality of amplified output signals, wherein each output signal corresponds to a column of pixels in the active pixel sensor array, and is based on the first value stored by the means for storing and a second value obtained by the CDS circuit corresponding to the column of pixels. As one example, each output signal can comprise a value of the difference between the first value and the second value, multiplied by a gain of the amplification circuit. As explained previously, the second value can be obtained by CDS circuitry by configuring circuitry in the manner illustrated in FIG. 6B, reading an output signal corresponding to each column one at a time while the csel switch for that column is activated.

The method of FIG. 10 can include one or more variations, depending on desired functionality. In some embodiments, for example, one or more additional switches may be activated to enable the amplification circuitry to provide a particular gain, as described above in relation to the embodiment shown in FIG. 8. A series of one or more muxes may additionally or alternatively be utilized to reduce parasitic capacitance from the second switch of each CDS circuit. In some embodiments, the third switch, located in the b circuitry, can be used as a voltage-zeroing switch connected to an input and an output of an op amp in the amplification circuitry, configured to cancel out a voltage offset in the op amp.

FIG. 11 illustrates an embodiment of a mobile device 1100, which can include a camera and/or another sensor with an active pixel array, and further incorporate the circuitry of the embodiments described herein above. For example, a CDS circuit as described herein may be included in a low power camera or vision sensor, such as an always-on vision sensor. It should be noted that FIG. 11 is meant only to provide a generalized illustration of various components, any or all of which may be utilized as appropriate. It can be noted that, in some instances, components illustrated by FIG. 11 can be localized to a single physical device and/or distributed among various networked devices, which may be disposed at different physical locations. It should also be noted that techniques herein may be implemented in electronic devices other than mobile devices.

The mobile device 1100 is shown comprising hardware elements that can be electrically coupled via a bus 1105 (or may otherwise be in communication, as appropriate). The hardware elements may include a processing unit(s) 1110 which can include without limitation one or more general-purpose processors, one or more special-purpose processors (such as digital signal processing (DSP) chips, graphics acceleration processors, application specific integrated circuits (ASICs), and/or the like), and/or other processing structure or means. The processing unit(s) 1110 may correspond to the processing unit of the previously-described embodiments. As shown in FIG. 11, some embodiments may have a separate DSP 1120, depending on desired functionality. The mobile device 1100 also can include one or more input devices 1170, which can include without limitation a touch screen, a touch pad, microphone, button(s), dial(s), switch(es), and/or the like; and one or more output devices 1115, which can include without limitation a display, light emitting diode (LED), speakers, and/or the like.

The mobile device 1100 might also include a wireless communication interface 1130, which can include without limitation a modem, a network card, an infrared communication device, a wireless communication device, and/or a chipset (such as a Bluetooth™ device, an Institute of Electrical and Electronics Engineers standard (IEEE) 802.11 device, an IEEE 802.15.4 device, a WiFi device, a WiMax device, cellular communication facilities, etc.), and/or the like. The wireless communication interface 1130 may permit data to be exchanged with a network, wireless access points, other computer systems, and/or any other electronic devices described herein. The communication can be carried out via one or more wireless communication antenna(s) 1132 that send and/or receive wireless signals 1134.

Depending on desired functionality, the wireless communication interface 1130 can include separate transceivers to communicate with base transceiver stations (e.g., base stations of a cellular network) access point(s). Additionally, a WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A wireless local area network (WLAN) may also be an IEEE 802.11x network, and a WPAN may be a Bluetooth network, an IEEE 802.15x, or some other type of network.

The mobile device 1100 can further include sensor(s) 1140. Such sensors can include, without limitation, one or more accelerometer(s), gyroscope(s), camera(s), vision sensor(s), magnetometer(s), altimeter(s), microphone(s), proximity sensor(s), light sensor(s), and the like. The camera(s) may include one or more of the components shown in the camera circuitry 100 of FIG. 1 or the embodiments of CDS circuits described throughout, with which the techniques described herein may be implemented. In other words, sensor(s) 1140 can include an APS array, CDS circuitry, and PGA configured in the manner described herein. The output can be a digital output (e.g., an output of an ADC), or it may be an analog output (e.g., provided to an ADC). In either case, the output may be provided to the processing unit(s) 1110 and/or the DSP 1120. Alternatively, or additionally, functions described herein as being performed by a processing unit, such as processing unit(s) 1110, can be performed by a dedicated microprocessor, controller, or control logic in sensor(s) 1140. Such a dedicated microprocessor, controller, or control logic can be included in peripheral circuitry in the sensor(s) 1140 to capture and process pixel values in the manner disclosed herein.

Some embodiments of the mobile device may also include a satellite positioning system (SPS) receiver 1180 capable of receiving signals 1184 from one or more SPS satellites using an SPS antenna 1182.

The mobile device 1100 may further include and/or be in communication with a memory 1160. The memory 1160 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 1160 of the mobile device 1100 also can comprise software elements (not shown), including an operating system, device drivers, executable libraries, and/or other code, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In particular, although embodiments described above include hardware components, techniques described herein (e.g., the method of FIG. 10 and/or the functionality generally described in relation to FIGS. 3-9) may be performed, in whole or in part, by instructions/code embedded on machine-readable media and executed by one or more processing units. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. An apparatus for providing image sensing, the apparatus comprising:
an active pixel sensor array comprising a pixel array having a plurality of columns of pixels;
for each column of pixels of the plurality of columns of pixels of the active pixel sensor array, a correlated double sampling (CDS) circuit corresponding to, and coupled with, the each column of pixels, wherein each CDS circuit comprises a first switch, a first capacitor, and a second switch, wherein, for each CDS circuit:
the first capacitor is connected in series between the first switch and the second switch without an active element disposed between the first capacitor and the second switch, and
an input of the first switch is coupled to an output of the corresponding column of pixels; and
an amplification circuit comprising a second capacitor and a third switch connected in parallel with the second capacitor, wherein, for the each CDS circuit, an output of the second switch of is coupled to an input of the amplification circuit.

2. The apparatus of claim 1, wherein the second capacitor is one of a plurality of capacitors connected in series in the amplification circuit and the amplification circuit further comprises a plurality of switches connected in parallel with the plurality of capacitors such that a capacitance, and an amount of amplification by the amplification circuit, can be adjusted using the plurality of switches.

3. The apparatus of claim 1, wherein the third switch comprises a voltage-zeroing switch connecting the input of the amplification circuit with the output of the amplification circuit when the third switch is turned on.

4. The apparatus of claim 1, further comprising at least one analog mux connecting the output of the each CDS circuit with the input of the amplification circuit.

5. The apparatus of claim 4, wherein the at least one analog mux provides a single output connected to the input of the amplification circuit.

6. The apparatus of claim 1, wherein the amplification circuit comprises an op amp connected in parallel with the second capacitor and the third switch.

7. The apparatus of claim 1, wherein:
the each CDS circuit is configured to obtain a first value and a second value from a pixel sensor in the each column corresponding to the each CDS circuit; and
the amplification circuit is configured to provide a plurality of output signals, each output signal based on the first value and the second value obtained by the each CDS circuit.

8. The apparatus of claim 7, wherein each output comprises a value of a difference between the first value and the second value, multiplied by a gain of the amplification circuit.

9. An method of providing image sensing, the method comprising:
obtaining, for each column of pixels in an active pixel sensor array, a first value from a pixel sensor in the column of pixels;
storing, for each column of pixels in the active pixel sensor array, the first value with a corresponding CDS circuit comprising a first switch, a first capacitor, and a second switch, wherein:
the first capacitor is connected in series between the first switch and the second switch without an active element disposed between the first capacitor and the second switch, and
an input of the first switch is coupled to an output of the corresponding column of pixels; and
providing, with an amplification circuit coupled to each of the CDS circuits, a plurality of output signals, wherein each output signal:
corresponds to a column of pixels in the active pixel sensor array, and
is based on the first value stored by the CDS circuit corresponding to the column of pixels and a second value obtained by the CDS circuit corresponding to the column of pixels; and
wherein the amplification circuit comprises a second capacitor and a third switch connected in parallel with the second capacitor.

10. The method of claim 9, wherein the second capacitor is one of a plurality of capacitors connected in series in the amplification circuit and the amplification circuit further comprises a plurality of switches connected in parallel with the plurality of capacitors, the method further comprising adjusting an amount of amplification by the amplification circuit using the plurality of switches.

11. The method of claim 9, wherein the third switch comprises a voltage-zeroing switch, the method further comprising connecting the input of the amplification circuit with the output of the amplification circuit by turning the third switch on.

12. The method of claim 9, further comprising operating least one analog mux to connect the output of the each CDS circuit with the input of the amplification circuit.

13. The method of claim 12, wherein the at least one analog mux provides a single output connected to the input of the amplification circuit.

14. The method of claim 9, wherein the amplification circuit comprises an op amp connected in parallel with the second capacitor and the third switch.

15. The method of claim 9, wherein, for each output signal of the plurality of output signals, the output signal comprises a value of a difference between the first value and the second value, multiplied by a gain of the amplification circuit.

16. An apparatus comprising:
means for obtaining, for each column of pixels in an active pixel sensor array, a first value from a pixel sensor in the each column of pixels;
means for storing, for each column of pixels in the active pixel sensor array, the first value within a corresponding CDS circuit that does not include a buffer or amplifier; and
means for providing a plurality of amplified output signals, wherein each output signal:
corresponds to a column of pixels in the active pixel sensor array, and
is based on the first value stored by the means for storing and a second value obtained by the means for storing corresponding to the column of pixels.

17. The apparatus of claim 16, wherein the means for providing a plurality of amplified output signals provides an adjustable amount of amplification.

18. The apparatus of claim 16, further comprising means for providing a single output connected to an input of the means for providing the plurality of amplified output signals.

19. The apparatus of claim 16, wherein the means for providing a plurality of amplified output signals comprises an op amp connected in parallel with a second capacitor and a third switch.

20. The apparatus of claim 16, wherein, for each output signal of the plurality of output signals, the output signal comprises a value of a difference between the first value and the second value, multiplied by a gain of the means for providing a plurality of amplified output signals.

21. A non-transitory computer-readable medium comprising instructions for causing an apparatus to provide image sensing, the instructions including computer code for:
obtaining, for each column of pixels in an active pixel sensor array, a first value from a pixel sensor in the column of pixels;
storing, for each column of pixels in the active pixel sensor array, the first value with a corresponding CDS circuit comprising a first switch, a first capacitor, and a second switch, wherein:
the first capacitor is connected in series between the first switch and the second switch without an active element disposed between the first capacitor and the second switch, and
an input of the first switch is coupled to an output of the corresponding column of pixels; and
providing, with an amplification circuit coupled to each of the CDS circuits, a plurality of output signals, wherein each output signal:
corresponds to a column of pixels in the active pixel sensor array, and
is based on the first value stored by the CDS circuit corresponding to the column of pixels and a second value obtained by the CDS circuit corresponding to the column of pixels; and
wherein the amplification circuit comprises a second capacitor and a third switch connected in parallel with the second capacitor.
